(19) United States
(12) Patent Application Publication
(10) Pub. No.: US 2017/0168431 A1
(43) Pub. Date: Jun. 15, 2017

(54) Multicolour Printing Process and a Liquid Toner Composition

(71) Applicant: Xeikon IP B.V., Eede (NL)

(72) Inventors: Lode Erik Dries Deprez, Wachtebeke (BE); Werner Jozef Johan Op de Beeck, Putte (BE)

(21) Appl. No.: 15/321,339

(22) PCT Filed: Jun. 25, 2015
(86) PCT No.: PCT/NL2015/050461

§ 371 Date: Dec. 22, 2016

(30) Foreign Application Priority Data
Jul. 2, 2014 (NL) 2013107

(51) Int. Cl. G03G 15/01

(52) U.S. Cl. CPC G03G 15/205; G03G 15/0105

(57) ABSTRACT

The digital printing process includes the printing of liquid toner on both substrate sides. Thereto developed portions of a first and a second liquid toner are transferred to the first side and fused by exposure to infrared radiation and by subsequent contact fusing. The substrate is conditioned for a further transfer step by maintaining a substantially uniform water content therein during and after the fusing step, in which further transfer step at least one further developed portion of liquid toner is transferred to a side of the substrate. This occurs particularly by limiting heat development in the liquid toner, such as by using a black toner liquid with an absorbance at 800 nm of at most than 0.8.

### FIELD OF THE INVENTION

The present invention relates to a multicolour digital printing process comprising
providing a first and a second liquid toner, each of which comprising toner particles and a substantially non-polar carrier liquid, wherein said first liquid toner comprises black toner particles and wherein said second liquid toner comprises toner particles in a colour different to black,
Transfer of developed portions of the first and the second liquid toner to a first side of a substrate,
Fusing said developed portions of the first and the second liquid toner into first and second toner films adhered on the substrate, comprising the steps of exposing the first side of the substrate to infrared radiation, and subsequent contact fusing,

The invention also relates to a multicolour digital printing apparatus, comprising
a first transfer station for transfer of a developed portion of a first liquid toner to a first side of a substrate;
a second transfer station for transfer of a developed portion of a second liquid toner to the first side of the substrate;
a fusing station comprising a source of infrared radiation emitted to the first side of the substrate, and means for contact fusing in the form of a plurality of heated rollers,

The invention further relates to a liquid toner composition for use in such a process.

### BACKGROUND OF THE INVENTION

Such a printing apparatus and such a printing process are known from US2010/0086336A1. The known apparatus comprises a series of four transfer stations for transfer of developed portions liquid toner to the first side of the substrate. Each transfer station comprises a photoconductor carrying a latent image onto which liquid toner is transferred from a developer member according to the said latent image. The resulting developed portion of liquid toner is then transferred, optionally via a further member to the substrate. Downstream of said transfer stations, a fusing station is present. The fusing station comprises two stages, the first one being an infrared heater and the second a series of heated rollers. The infrared heater of the prior art is designed for drying the substrate in a short time by evaporation of the carrier liquid that is particularly absorbed by the substrate. More particularly the infrared heater emits radiation in either a wavelength of 1.2-1.7 μm or 2.0-2.5 μm to increase the temperature of a heated target (i.e. the carrier liquid) in a short time of approximately 1-3 seconds. This is advantageous for high speed printing and an alternative for the removal of carrier liquid by blowing heated air. The series of heated rollers of the prior art, which are heated by an infrared heater of the same type, ensures attachment of the toner to the substrate by heat and pressure due to the nipping operation of the substrate by the pair of heated rollers. Due to the use of a plurality of heated rollers set in series, a stable fixed state without unevenness can be obtained. Therewith, damage such as paper creasing or stretching of the paper can be suppressed.

It would be advantageous to provide a multicolour digital printing process and apparatus that is feasible of duplex printing and/or the provision of more than four colours. One implementation thereof would be the provision of a further section with transfer stations and a fusing station downstream of the fusing station shown in the above mentioned patent application.

However, in preliminary experiments with a printing apparatus comprising such a further section, it was found that the images were not printed correctly at the second side. In these preliminary experiments, use was made of transfer stations wherein transfer took place electrostatically. Use was made of the same liquid toners of cyan, yellow, magenta and black colours in the first and the subsequent transfer stage. The said pigments were incorporated in toner particles comprising a polyester binder resin. A mineral oil was used as a carrier liquid. Carbon lamps with emission in the range from 800 nm up to 2.0 μm were used as infrared radiation sources. The contact fusing was carried out with heated rollers at a temperature of 125° C. More particularly, the printing at the second side was of insufficient density in many locations.

### SUMMARY OF THE INVENTION

It is therefore a first object of the invention to provide a multicolour digital printing process for liquid toner of the type mentioned in the opening paragraph wherein more than four colours may be printed on a substrate, for instance in duplex printing, and suitably in a high speed printing process of at least 0.5 m/s and more suitably at least 0.7 m/s or even at least 1.0 m/s.

It is a second object of the invention to provide a multicolour digital printing apparatus of the type mentioned in the opening paragraph for correct high-speed duplex printing and other printing of more than four colours, the latter meaning at least four colours on one side.

It is a further object of the invention to provide a liquid toner composition suitable for such a multicolour digital printing process.

According to a first aspect of the invention, a multicolour digital printing process of the type defined in the opening paragraph is provided, wherein the process comprises the further step of carrying out a further transfer step, wherein at least one further developed portion of liquid toner is transferred to a side of the substrate, and wherein the substrate is conditioned for the further transfer step by limiting heating up of the first film, such that the first and the second toner films warm up under exposure to the infrared irradiation to temperatures differing at most 15° C. According to a second aspect of the invention, a multicolour digital printing apparatus of the type defined in the opening paragraph is provided, arranged for the process of the invention, and further comprising downstream of said fusing station at least one further transfer station for transfer of a developed portion of liquid toner to a side of the substrate, and a further fusing station comprising a source of infrared radiation emitted to the first side of the substrate, and means for contact fusing in the form of a plurality of heated rollers.

According to a third aspect of the invention, a liquid toner composition is provided that comprises black toner particles in a substantially non-polar carrier liquid, wherein the first liquid toner has an absorbance at 800 nm of at most 0.8, after application on a substrate and fusing to obtain an optical density in the range of 1.8 and 1.9 in the visual range of the light spectrum (wavelength of 390-700 nm), which absorbance is defined as a logarithmic ratio of an intensity of reflected light from the printed substrate to an intensity of reflected light from the unprinted substrate.

The inventors of the present invention have understood that it is required for a correct further printing, for instance printing on the second side of the substrate, that the dielectric properties of the substrate remain preferably unchanged and if they would change, they should change uniformly over the whole surface of the substrate. These dielectric properties turn out highly important in the electrostatic transfer step to the substrate, i.e. a substrate with changed dielectric properties will have different transfer properties from the photoconductor. The inventors have further understood that this change in dielectric properties was due to evaporation of water from the substrate. Moreover, it occurred in a non-uniform manner, i.e. particularly in substrate portions underlying the black toner. When controlling the process to prevent such evaporation of water, the previously observed errors in the further printing, particularly on the other, second side, were prevented.

More particularly, the process should be controlled and tuned so as to ensure that the first film processed from the first liquid toner does not act as a heat source for the underlying substrate portion. The exposure to infrared irradiation according to the invention, particularly with the preferred carrier liquid and/or binder resin, results in a toner film that is adhered to the substrate. Therefore, if the first toner film has become too hot, it will start to transfer heat to the substrate. Due to the arrangement as a film adhered to the substrate, there is a low resistance to such heat transfer, and the substrate may heat up very quickly and also irregularly (dependent upon the image content). Moreover, since the toner film is present on first side, and the substrate is typically open (i.e. not closed by any insulating film on the other side), the water may easily get out of the substrate via the other side. It was found that the heat absorbed from infrared irradiation by toner particles comprising carbon black as the sole pigment will heat up the toner film and underlying substrate very much. This is in itself not an issue, as long as there is no subsequent transfer carried out. Therefore, in one aspect of the invention, a liquid toner composition comprising black toner particles is provided with a specific absorbance at 800 nm. This absorbance is preferably at most 0.8 in accordance with the invention, and more preferably at most 0.7. The absorbance could even be much lower, for instance at most 0.4. However, this higher absorbance provides a margin that is suitable for obtaining a black with a very good optical density.

Reference is made to US2002/0141791A1 that discloses a dry toner process including a crosslinking step of toner film by means of UV radiation. This crosslinking increases the glass transition temperature of the toner after/during fusing, as a consequence of which the toner film does not become liquid again when depositing and fusing toner on the second side. This finally leads to a duplex printed substrate that has less gloss differences between the two printed sides than in a regular dry toner process without cross-linking. It is alleged that the same process also works for liquid toner. However, crosslinking of the toner film by UV radiation may only occur after co-agulation of the toner particles. As this co-agulation only occurs after heating, for instance with infrared heating, US2002/0141791A1 does not contribute to solving the problem of the invention, i.e. to prevent printing artefacts which are understood by the inventors to be due to differential heating up of the different liquid toners particularly during infrared radiation.

The change in dielectric properties of the substrate is most dominantly found in substrate portions underlying the black toner particles. This change could be prevented if the temperature of the first toner film comprising the black toner after the fusing step does not deviate too much from the temperature of the second toner film comprising another toner or the substrate without toner. Good results have been observed when the temperature difference was at most 15 degrees Celsius, for a fusing process, wherein the toner was fused in a test fusing set up. This test set up contained an infrared irradiation source with 6 carbon lamps of 4 kW each, and a contact fusing means of six roller pairs operated at 120° C.

The invention is deemed particularly important for liquid toners comprising a non-evaporative carrier liquid, i.e. a carrier liquid that does not evaporate at the fusing conditions. Examples thereof are mineral oils and vegetable oils. When evaporation occurs upon exposure to infrared irradiation, the temperature increase of the toner is reduced by the heat consumed in the evaporation process. With a non-evaporative carrier liquid such a limitation of temperature increase is not available. The use of a non-evaporative carrier liquid is however beneficial for other reasons, particularly so as to avoid contamination of the apparatus, to avoid spread of organic hydrocarbons into the room or atmosphere where the printer apparatus is located and to recycle such carrier liquid efficiently. Furthermore, mechanical removal is a quicker and less energy consuming process than evaporation. This helps to achieve the high-speed printing process. The carrier liquid removal may occur downstream or upstream to the exposure to infrared irradiation and downstream of the contact fusing. It is also feasible that removal of carrier liquid occurs both downstream and upstream of the exposure to infrared radiation.

The black toner according to the invention is suitably a composite black toner comprising a plurality of pigments. Carbon black (CI Pigment Black 7) may be one of the pigments, but more preferably at most in an amount of 20 wt % of the total pigment and/or dye. Good results have been achieved with toner particles comprising a mixture of cyan, magenta and yellow pigment. Preferably, a dark pigment is present in addition to said mixture. The dark pigment is for instance a dye, a small amount of carbon black or a mixture of blue and orange, but could alternatively be another source of black as known to the skilled person.

More preferably, such composite black toner is prepared with a content of pigment particles in the range of 20-35 wt %. Lower contents of pigment or dye particles will not have a desired optical density. Higher contents of pigment or dye particles tend to have an excessively high particle resin viscosity, which hinders the fast formation of a uniform film. The concentration of the toners particles should also be not too high since this may result in the caking of toner particles. Such caking may be formed on the development member or roller, particularly after a pattern of the liquid toner thereof has been transferred to the photoconductor.

The toner particles are suitably prepared to have a volume based median particle size in the range of 1.0 to 4.0 μm, more preferably 1.5-2.5 μm. This particle size is for instance measured with a diffractometer equipment as commercially available under the tradename Mastersizer 2000 or 3000 from Malvern. Preferably, the toner particles are ellipsoid in form. This form turns out suitable to obtain a good packing on the substrate surface.

The toner further comprises a binder resin and a dispersing agent, as known to the skilled person. The binder resin is for instance a polyester. The dispersing agent is suitably of the hyper-dispersant type, comprising an anchoring part with a plurality of anchoring sites to adhere to the toner particle's surface. This type of toner suitably comprises a plurality of substantially non-polar substituents or tails for stabilisation into the carrier liquid. The anchoring part is suitably based on a polyamine, such as a polyallylamine or a polyalkylenemine. It has been found that the dispersing agent dissolves into the binder resin under the heat provided by the infrared heater. Therewith, the stability of the toner particles in the carrier liquid reduces and the toner particles will show coalescence into a film.

The invention further relates to the use of the liquid toner composition of the invention for in a digital printing process (i.e. of the invention) wherein the liquid toner is transformed into a fused film adhered on a substrate by infrared radiation, for reduction or avoidance of subsequent heat emission from the fused film to the substrate. Surprisingly, the liquid toner composition of the invention turns out to enable duplex printing at high speed, in that the dielectric properties of the substrate are not modified in a inhomogeneous way. Preferably, the heat emission is at least reduced in such a manner that it is no longer colour dependent, i.e. significantly more for black or other dark colours than for the standard colours in printing, i.e. cyan, yellow and magenta. Significantly more would herein be twice as much, more particularly 1.5 times as much. More specifically, the heat emission is so much reduced that any consequent evaporation of water in the underlying substrate portion is substantially avoided.

The inventors are of the opinion that due to the fact that the carrier liquid is non volatile, the place which is created within the substrate due to the evaporation of water (conductive liquid), is taken immediately by the carrier liquid, which is a non conductive liquid. This results in a change in the dielectric properties of the substrate, i.e. the conductivity. It is found that this change is quite irreversible. The invention further relates to liquid toner compositions comprising black toner particles in a substantially non-polar carrier liquid, wherein the liquid toner comprises black toner particles with at most 20 wt % of carbon black (CB7) pigment relative to the total pigment. Good results for duplex printing have unexpectedly been observed with such a toner. That specifically relates to such liquid toners with a carrier liquid having a boiling point above 120° C. Such carrier liquids are for instance mineral oils such as obtainable from Sonneborn Inc, vegetable oils from Cargill or oils derived from chemical sources by chemical means. The toner suitably comprises black toner particles containing 20-35 wt % pigment or dye, even more preferably 25-35 wt %. This allows to obtain a good optical density and a particle viscosity that allows milling and other processing into a stable dispersion, and largely prevents the generation of caking on the developer roller in amounts that cannot be dealt with. Other features of the liquid toner composition as described hereinabove are also applicable to this aspect of the invention.

### INTRODUCTION TO THE FIGURES

These and other aspects of the invention will be further elucidated with reference to the figures, which are diagrammatical in nature and not drawn to scale and wherein:

FIG. 1 is a schematic view illustrating a first embodiment of the invention;

FIG. 2 is a schematic view illustrating a further embodiment of the invention.

### DETAILED DISCUSSION OF ILLUSTRATED EMBODIMENTS

The Figures are not drawn to scale and purely diagrammatical in nature. Equal reference numerals in different Figures refer to equal or corresponding features.

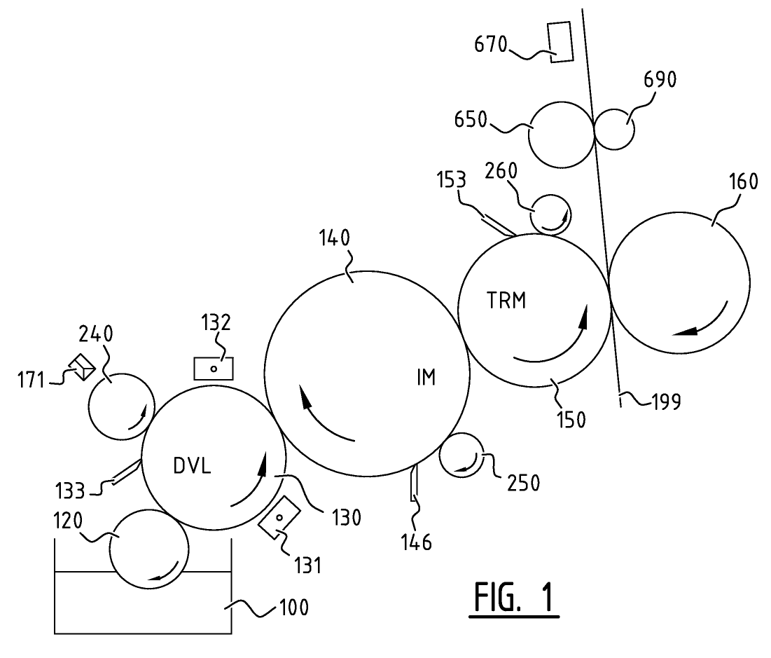

FIG. 1 illustrates diagrammatically a first embodiment of a digital printing apparatus of the invention, for setting out in more detail the overall process of the invention. The apparatus shown in FIG. 1 comprises a reservoir 100, a feed member 120, a toner member 130, an imaging member 140, an intermediate member 150 and a support member 160. A substrate 199 is transported between intermediate member 150 and support member 160. The substrate is suitably a paper substrate, i.e. comprising cellulose-fibers, or a substrate comprising a paper backing. Both the development member 130 and the imaging member 140 and also the intermediate member 150 can function as the first member according to the invention, and are shown to be provided with a removal device 133, 146, 153, and with treatment means 132, 240, 250, 260. Without loss of generality, the aforementioned members are illustrated and described as rollers, but the skilled person understands that they can be implemented differently, e.g. as belts.

In operation, an amount of liquid toner dispersion, initially stored in a liquid toner dispersion reservoir 100, also called main reservoir, is applied via a feed member 120, to a development member 130, an imaging member 140, and an optional intermediate member 150, and finally to a substrate 199. The development member 130, imaging member 140, and intermediate member 150 all transfer part of the liquid toner dispersion 100 adhering to their surface to their successor; the part of the liquid toner dispersion 100 that remains present on the member's surface, i.e. the excess liquid toner dispersion, which remains after selective, imagewise transfer, is removed after the transfer stage by appropriate means. The development member 130, the imaging member 140 and the intermediate member 150 may all act as the first member.

The charging of the toner on the development roll is done by charging device 131. This charging device can be a corona or a biased roll. By charging the toner the liquid toner dispersion splits into an inner layer at the surface adjacent of the development member 130 and an outer layer. The inner layer is richer in toner particles and the outer layer is richer in carrier liquid. The transition between these two layers may be gradual.

Upon transfer of the liquid toner dispersion from the development member 130 to the imaging member 140, excess liquid toner dispersion is left on the development member 130. Ideally, this excess liquid toner dispersion is present only in “non-image” areas, i.e. areas not corresponding to the image to be printed on the substrate, which is specified by the imaging member. However, it is not excluded that a thin layer remains on the development roller 130 at the area of the transferred image.

FIG. 1 further shows a discharging corona 132 that is provided downstream of the area of the rotational contact between the toner roller 130 and the imaging roller 140. The discharging corona 132 is suitable for changing/removing the charge in the dispersion. Further, downstream of the discharge corona 132 there is provided an additional member 240. In this example, the additional member is embodied as a loosening roller, which is provided with a rubbing portion. This is useful for improvement of mixing of the excess liquid toner dispersion with the added spacer agent. Similar loosening rollers 250, 260, which could be simply addition rollers without a dedicated rubbing portion, are present in rotational contact with the imaging member 140 and the intermediate member 150 respectively. Thereafter, a removal device is present, which most suitably is a scraper 133. The removed material is preferably recycled into fresh liquid toner.

A sensitive step in the printing process is the fusing of the liquid toner. This fusing is to result in coalescence of the toner particles on the paper. Typically use is made of a heat treatment that takes place shortly before, during or more preferably shortly after the transfer of the dispersion to the substrate. The term ‘coalescence’ refers herein to the process wherein toner particles melt and form a film or continuous phase that adheres well to the substrate and that is separated from any carrier liquid. Suitably, the carrier liquid is thereafter removed in a separate step, for instance by means of rollers, by means of blowing off the carrier liquid, by means of suction. Suitably, this process occurs at “high speed”, for instance 50 cm/s or more, so as to enable high-speed printing. During the fusing it is necessary to avoid formation of an emulsion, since an emulsion does not give a good printing image because film formation is omitted. The presence of the spacer agent(s) does not or not significantly interfere with this filming behaviour at elevated temperature.

According to the invention, the fusing is carried out by means of a combination of non-contact coalescence in the form of infrared irradiation and contact fusing. Preferably use is made of a source of infrared radiation in the near-infrared range (NIR), such as with a wavelength of up to 2000 nm. It was found that such sources can be operated fast enough so as to enable a high-speed process. One type of suitable infrared sources is carbon lamps. The non-contact coalescence results in the formation of a film that is already adhered to the substrate. The contact fusing enhances the adhesion and improves gloss of the film.

In one embodiment of the invention, use is made of a liquid removal unit 650 that removes liquid from the substrate 199. One important advantage of carrier liquid removal is that this carrier liquid may be recycled and reused within the machine. The liquid removal unit 650 is suitably embodied as a member that is in rotational contact with the substrate, or at least with an outer layer of the liquid toner dispersion transferred to the substrate. It is deemed suitable to provide a counter-member 690 at the opposed side of the substrate 199. The liquid removal unit 650 is particularly provided upstream of a contact fusing unit 670. In this manner formation of a ghost fusing image is prevented, which is believed to be due thereto, that too much carrier liquid is available in the liquid toner dispersion during fusing, especially when a plurality of liquid toner dispersions—transferred from separate imaging stages—are present on top of each other on the substrate 199. The inventors have observed that, in order to avoid ghost fusing patterns, removing the carrier liquid before non-contact fusing is much more adequate than removing the carrier liquid during contact-fusing, i.e. by means of hot rollers. Moreover, the amount of liquid to be removed may be controlled in dependence of the substrate type.

In one embodiment, the non-contact type fusing is preceded by the liquid removal on the substrate. This increases the efficiency of the non-contact coalescence that any non-contact fusing may be carried out in an efficient manner. Moreover, because of the combination of liquid removal and non-contact coalescence, the heat requirement of this coalescence step will be somewhat reduced, as less carrier liquid is present. In another embodiment, the non-contact type fusing precedes the liquid removal. This order has the advantage that the liquid removal may be highly efficient. The infrared irradiation will induce film formation so that no electric field may be needed for the layer removal. Moreover, this order increases the time between the irradiation step and the contact fusing (in comparison to the other alternative or no liquid removal at all). That allows that the film formation may have longer duration, i.e. that the dispersing agent is further dissolved into the binder resin and particles have further fused at the start of the contact fusing. Furthermore, and not unimportantly, it has been observed that the film formation upon IR irradiation results in liberation of carrier liquid hidden or dispersed around the toner particles through chemisorption of the carrier liquid by the dispersing agents on the surface. Carrying out any liquid removal step subsequent to the IR irradiation thus enables removal of this liberated carrier liquid.

In a further implementation of this preferable embodiment, a first carrier liquid removal unit is provided upstream of the means for non-contact coalescence and a second carrier liquid removal unit is provided downstream of said means for non-contact coalescence but upstream of the means for contact-fusing. The order of steps is then a first carrier liquid removal step, a non-contact coalescence step, a second carrier liquid removal step and a contact fusing step. This implementation further reduces the possibility of ghost fusing to occur.

In a preferred embodiment, use is made of a liquid removal unit 650 comprising means for applying a voltage difference over the liquid toner dispersion. This means are suitably embodied as an electrical conductor coupled to any voltage source. The counter-member 690 herein constitutes the counter electrode. The voltage is herein applied in such a manner that the charged toner particles are pushed to the substrate 199, such that carrier liquid and toner particles are split up between a first and a second layer. The second, outer layer of carrier liquid may then be removed with the removal unit 650. The removal unit 650 may thereto be porous, and could further comprise means for absorption or suction. Alternatively, the carrier liquid may be adhered to a surface of the rotational member of the removal unit 650, and therewith be removed. The adhered liquid film will again be removed from the rotational member. This can be done, in one suitable embodiment with a scraper device.

Rather than applying a positive or negative voltage to the removal unit 650, the unit could be coupled to ground, whereas an appropriate voltage is applied to the counter-member 690.

Rather than applying a voltage difference continuously, this could be done under the control of a control device, particularly for situations, in which a large volume of toner is transferred to the substrate 199 and a large volume of carrier liquid is to be removed. Such situations could for instance be the situations wherein the number of colours (applied from different imaging stages) exceeds a predefined number. Furthermore, such situations could involve situations wherein the pattern results in transfer of a high amount of liquid toner to the substrate; this is the case wherein the pattern is ‘rather full’ instead of being ‘predominantly empty’. Photos typically contain a rather full pattern, whereas the printing of letterhead on paper is an example of a rather empty pattern.

In a further implementation, the liquid toner dispersion is subjected to a further charging treatment after its transfer to the substrate 199 and before removal of carrier liquid in the liquid removal unit 650. The charging treatment is for instance applied by means of a charging unit (not shown), and is for instance a corona treatment. Such a treatment ensures that the charged toner particles are pushed or drawn to the substrate 199.

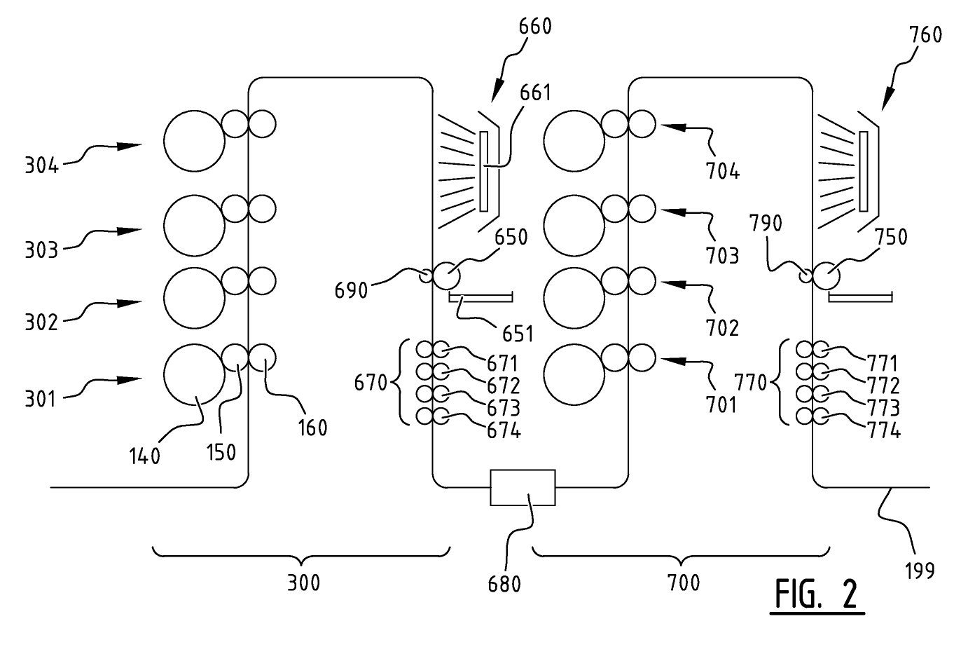

FIG. 2 shows a further view of the apparatus in a further embodiment. In fact, this FIG. 2 shows the apparatus on a higher level. While FIG. 1 specified in fact the operation of a single transfer station for a single liquid toner in combination with the fusing, FIG. 2 discloses the overall layout comprises a first section 300 with a plurality of transfer stations 301-304 and the fusing station 660, 670, as well as a second section 700 with again a plurality of transfer stations 701-704 and a fusing station 760, 770. A turning unit 680 is present between the first section 300 and the second section 700 so as to turn the paper upside down. Such a turning unit 680 is however not indispensable. Rather, in the event that the second section 700 is foreseen to print additional colours to the same side of the paper 199, this is not needed.

Each of the transfer stations 301-304 and 701-704 is foreseen for transfer of liquid toner of a specific colour to the substrate 199. Each transfer station is organized as shown in FIG. 1, with a development member, an image member 140 (also known as photoconductor), an intermediate transfer member 150 and a counter member 160. For sake of clarity, only the image member 140, the intermediate transfer member 150 and the counter member 160 are shown in this FIG. 2. A liquid removal unit 650, 750 is present between the means for non-contact coalescence 660, 760, more particularly the infrared irradiation unit, and the contact fusing unit 670, 770. Herewith, carrier liquid liberated from the toner particles in the film formation process resulting from the heating by means of infrared radiation can be removed. Roller 690, 790 is present for stability purposes in this embodiment. The contact fusing station 670, 770 is provided, according to the shown example, with a series of four pairs of heated rollers 671-674, 771-774. These rollers are suitably heated, for instance by means of heat radiation, so as to operate at the desired temperature. While, in one embodiment, all rollers 671-674 are operated at the same temperature, this is not strictly necessary.

It will be understood that variations to this general layout are not excluded. A third section could be added. Each section could contain a number of transfer stations different from four. Furthermore, additional liquid removal units may be present. Furthermore, it is not deemed necessary, though believed beneficial for the sake of uniformity, that the first section 300 and the second section 700 are fully identical.

### EXAMPLES

Characterization of the Liquid Toner

Tests were carried out with the digital printing process and apparatus as described in the foregoing. Herein, the liquid toner composition was characterized by means of its absorbance at 800 nm, its viscosity, its glass transition temperature, and its optical density.

Absorbance

The absorbance is defined as the logarithmic ratio of the intensity of the reflected light of a printed sample relative to the intensity of the reflected light of an sample free of printing. The absorbance is measured with a Stellarnet spectrofotometer type Black comet model C in reflection mode at 800 nm, using a R600-8-UVVIS-SR reflectance probe held at a 45° angle.

The samples used in the absorbance test were prepared by application of a toner layer by a bar coater on a 170 gsm coated paper commercially available from UMP under the tradename Digifinesse™. The thickness of the layer was adjusted to obtain an optical density after fusing between 1.8 and 1.85 as measured with a Gretag D19C densitometer. The image was fused in an oven heated to 125° C. during 5 minutes.

Viscosity

The dynamic viscosity |η| of the toner particle is measured (in mPa·s) at 100° C. during a temperature sweep from 80 to 120° C. in an oscillatory mode in a plate-plate geometry of 25 mm at a frequency of 1 Hz with a rheometer type AR2000 from TA Instruments.

The toner particle is prepared for the viscosity measurement by first pressing the particle into a pellet of approximately 1 mm thick. The toner particle has a particle size of approximately 10 μm This pellet is put between the plates of the rheometer followed by a temperature equilibration at 80° C. for 10 min before starting the measurement.

Glass Transition Temperature

The glass transition temperature T_{g} of the toner particle is measured according to ASTM D3418 with a model Q20 from TA instruments.

Optical Density

The optical density of the printed toner film, as prepared in accordance with Example 3, in the manner corresponding to FIGS. 1 and 2, is measured with a Gretag densitometer type D19C. This apparatus performs a diffuse reflection measurement, not including specular reflection. A liquid toner layer of 4.5 to 5 μm was applied on the development roller 130 as shown in FIG. 1.

### Example 1—Preparation of the Liquid Toner Compositions

A liquid toner dispersion comprising a toner particle, a carrier liquid and a dispersing agent is prepared. The ingredients used to prepare the toner particles and the liquid toner dispersions are summarized in Table 1.

TABLE 1
ingredients

| | Name | Description |
|---|---|---|
| Polymer | PM1 | polyester resin with an acid value of 12 mg |
| | | KOH/g, a Tg of 60° C. (1) and a Tm of 99.8° C. (1) |
| Additive | AD1 | Toluene sulfonamide |
| Pigment | PIG1 | Pigment black 7 (carbon black) |
| | PIG2 | PB 15:3 (cyan) |
| | PIG3 | PY185 (yellow) |
| | PIG4 | PR57:1 (magenta) |
| | PIG5 | PO72 (orange) |
| | PIG6 | PB61 (blue) |
| | PIG7 | PB25 (brown) |
| | PIG8 | SB45 (black dye) |
| Dispersing | DA1 | polymeric dispersing agents with a polyethylenimine |
| Agent | | backbone and polyhydroxystearate grafts having a base |
| | | equivalent (2) of 560-620 |
| Liquid | LIQ1 | mineral oil having a viscosity of 5 mPas |
| | | measured at 1 Hz at 25° C. |

(1) measured according to ASTM D3418
(2) the amount of dispersing agent that is needed to neutralize 1 mol of acid

Table 2 shows the composition of the toner particles. The toner particles are prepared by kneading the ingredients of Table 2 at a temperature of 100 to 120° C. for 45 minutes. This mixture is cooled down and milled down to obtain particles with a size of about 10 μm using a fluidized bed mill. Toner particles 1 and 5-12 are black toner particles. Toner particles 2, 3 and 4 are magenta, yellow and cyan.

TABLE 2
Composition of toner particles

| Toner | | | | | | | | | | |
|---|---|---|---|---|---|---|---|---|---|---|
| particle | PM1 | pig 1 | pig 2 | pig 3 | pig 4 | pig 5 | pig 6 | pig 7 | pig 8 | AD1 |
| 1 | 77 | 17 | | | | | | | | 6 |
| 2 | 82 | | 12 | | | | | | | 6 |
| 3 | 82 | | | 12 | | | | | | 6 |
| 4 | 79 | | | | 15 | | | | | 6 |
| 5 | 77 | | 6 | 6 | 6 | | | | | 6 |
| 6 | 62 | | 10 | 10 | 10 | | | | | 8 |
| 7 | 62 | 9 | 7 | 7 | 7 | | | | | 8 |
| 8 | 62 | 4.5 | 8.5 | 8.5 | 8.5 | | | | | 8 |
| 9 | 62 | | | | | | | | 30 | 8 |
| 10 | 62 | | 5 | 5 | 5 | | | 15 | | 8 |
| 11 | 62 | 10 | | | | | | 20 | | 8 |
| 12 | 62 | | 7 | 7 | 7 | 4.5 | 4.5 | | | 8 |

The prepared toner particles 112 were used for the preparation of liquid toner dispersions LD1LD12. Herein, the toner particles 1, 5-12 were black toner particles. First, a pre-dispersion of the ingredients shown in Table 3 is prepared by stirring the ingredients during 10 minutes at room temperature. The pre-dispersion is thereafter brought into a liquid milling device. The liquid toner dispersion is milled down with a bead mill type PML2 from Buhler AG with a tip speed of 5 to 9 m/s to a obtain a volume based median particle size (dv50) of 1.5 to 2.5 μm. Finally, the liquid toner dispersions are diluted with the liquid LIQ1 to obtain a solid content of 25%.

TABLE 3
liquid toner dispersion concentrate composition

| | toner particles | | dispersing agent | | carrier liquid | |
|---|---|---|---|---|---|---|
| | | amount | | amount | | amount |
| | type | (wt %) | type | (wt %) | Liquid | (wt %) |
| LD1 to 12 | Marking | 35 | DA1 | 3 | LIQ1 | 62 |
| | particle 1 | | | | | |
| | to 12 | | | | | |

### Example 2—Characterization of the Liquid Toner Compositions

The liquid toner compositions LD1-LD12 were characterized by means of their physical properties: optical density, absorbance, viscosity and glass transition temperature. It is observed for sake of clarity that the toners 2, 3 and 4 have a significantly lower toner particle viscosity, which is due to the lower pigment concentration. It is further observed that the LD toners 8 and 10, while including a different mixture of pigments demonstrate an absorbance at 800 nm that is relatively similar. The same observation is made for the toners LD6 and LD9, even though LD6 contains a pigment mixture and LD9 contains a dye.

TABLE 4
physical properties of liquid toner compositions

| | | | Viscosity | |
|---|---|---|---|---|
| | Optical | Absorbance | (η*, mPa · s) of toner | Tg |
| LD toner | density | at 800 nm | particle at 100° C. | (° C.) |
| 1* | 1.85 | 1.55 | 1980 | 48 |
| 2 | 1.47 | 0.12 | 725 | 47.3 |
| 3 | 1.42 | 0.18 | 847 | 46.8 |
| 4 | 1.53 | 0.15 | 930 | 48.2 |
| 5** | 1.16 | 0.19 | 1578 | 47.1 |
| 6 | 1.81 | 0.24 | 2320 | 40.4 |
| 7* | 1.94 | 1.09 | 1874 | 39.8 |
| 8 | 1.83 | 0.57 | 2089 | 41.1 |
| 9 | 1.9 | 0.22 | 2723 | 42.2 |
| 10** | 1.24 | 0.63 | 2210 | 38.9 |
| 11* | 1.62 | 1.12 | 2157 | 39.2 |
| 12 | 1.75 | 0.25 | 1925 | 39.7 |

*comparative examples
**very low optical density (lower than 1.3), not preferred.

### Example 3—Printing Test with the Liquid Toner Compositions

This example was carried out with a printing apparatus as shown in FIG. 2

A liquid toner composition with a solid content of 25 wt % is applied to a development roller, so as to form a toner layer with a thickness of 5 μm. The liquid toner is transferred to the imaging member (140) according to the pattern defined on the imaging member as the latent image. The pattern is a so called colour patch, which is a strip in the specified colour with a width of 3 cm and a length of at least 20 cm. The colour patches of different colours were designed so as to be printed on a single substrate adjacent to each other. This was done to minimize the effect of the substrate. The liquid toners used as specified in Table 5.

TABLE 5

| | Black | Cyan | Yellow | Magenta | |
|---|---|---|---|---|---|
| Print | liquid | Liquid | liquid | liquid | IR duty |
| sample | toner | toner | toner | toner | cycle |
| 1 | LD 1 | LD 2 | LD 3 | LD 4 | 80 |
| 2 | LD5 | LD 2 | LD 3 | LD 4 | 80 |
| 3 | LD6 | LD 2 | LD 3 | LD 4 | 80 |
| 4 | LD7 | LD 2 | LD 3 | LD 4 | 80 |
| 5 | LD8 | LD 2 | LD 3 | LD 4 | 80 |
| 6 | LD9 | LD 2 | LD 3 | LD 4 | 80 |
| 7 | LD10 | LD 2 | LD 3 | LD 4 | 80 |
| 8 | LD11 | LD 2 | LD 3 | LD 4 | 80 |
| 9 | LD12 | LD 2 | LD 3 | LD 4 | 80 |
| 10 | LD 1 | LD 2 | LD 3 | LD 4 | 60 |

This visual image is then transferred via an intermediate transfer member (150) to the substrate (199), as indicated schematically hereinabove with reference to FIG. 1. The substrate was a coated paper substrate of 115 gsm, which is commercially available from UPM under the tradename Digifinesse™. The station 660 for non-contact coalescence included six carbon lamps for infrared radiation, each of which had a maximum power of 150 kW/m2. No liquid removal unit was present. The contact fusing unit 670 included six pairs of rollers operated at 120° C. The linear speed of the substrate along the fusing unit was 1 m/s. The duty cycle of the infrared radiation is specified in Table 5 for each print sample.

Subsequently, the second side of the substrate is printed. Herein, use is made again of a pattern of colour patches of different colours. The colour patches printed on the second side extend in a direction perpendicular to those printed on the first side to check which colour combination possibly results in a more difficult or inhomogeneous transfer in the second tower.

### Example 4—Test Methods of the Printed Samples

The temperature of the different colourpatches was measured by a non contact IR thermometer type Proscan 510 immediately after the exposure to the infrared irradiation on the first side and before contact fusing.

Ghost transfer is reviewed after the printing including fusing on the second side. The ghost transfer is observed visually by inspecting the difference in transfer at the backside between areas, where black is printed and where no black is printed at the first side.

The result is ranked as follows from 1 (no ghost transfer) to 5 (ghost transfer):

1=very good: no difference

2=good: almost no difference

3=acceptable: small difference is observed

4=not acceptable: clear difference is observed

5=very bad: very clear difference

Adhesion of the printed image was tested by means of a tape test. This tape test is performed according the FINAT test method no 21 (see www.finat.com). Use is made of 3M Scotch 810 Magic tape.

### Example 5—Test Results of the Printed Samples

The results of the temperature sensing of the patches on the first side, the ghost transfer on the second side and the adhesion strength are listed in Table 6. Further included is the absorbance of the liquid toner.

TABLE 6
results from the printing test

| | Absorbance | Temperature (° C.) | | | Temperature difference (° C.) | | | | |
|---|---|---|---|---|---|---|---|---|---|
| Print | at 800 nm | Sub- | cyan | Black | Cyan- | Black- | Black- | Ghost | Adhe- |
| sample | Black | strate | patch | patch | substrate | substrate | Cyan | transfer | sion |
| 1* | 1.55 | 77 | 78 | 119 | 1 | 42 | 41 | 5 | 1 |
| 2 | 0.19 | 78 | 80 | 83 | 2 | 5 | 3 | 1 | 1 |
| 3 | 0.24 | 79 | 79 | 86 | 0 | 7 | 7 | 1 | 2 |
| 4* | 1.09 | 77 | 78 | 102 | 1 | 25 | 24 | 4 | 1 |
| 5 | 0.57 | 77 | 79 | 88 | 2 | 11 | 9 | 2 | 1 |
| 6 | 0.22 | 78 | 80 | 85 | 2 | 7 | 5 | 1 | 2 |
| 7 | 0.63 | 78 | 79 | 89 | 1 | 11 | 10 | 2 | 1 |
| 8* | 1.12 | 76 | 77 | 105 | 1 | 29 | 28 | 4 | 1 |
| 9 | 0.25 | 76 | 78 | 86 | 2 | 10 | 8 | 1 | 2 |
| 10* | 1.55 | 65 | 66 | 89 | 1 | 24 | 23 | 3 | 4 |

*not according to the invention

The results demonstrate that good printing results are achieved when the temperature difference between the patches of black and cyan is less than 15° C. This result turns out to correspond well with the absorbance test of the liquid toner. It is further shown in print sample 10, that the reduction of the infrared duty cycle to 60% tends to improve the printing on the second side, but against an unacceptable decreased adhesion strength. This not merely confirms the relevance of the temperature difference as indicator, but also implies that the infrared radiation is needed for correct fusing of the liquid toners of the invention. The lower duty cycle moreover results in a lower temperature of the substrate and the cyan patch. This implies that there is a high risk for bad adhesion or coalescence. Therefore, the temperature of the substrate having colours is preferably at least 70° C., so as to achieve proper fusing, for samples processed in accordance with the protocol set out in Example 3.

Thus in summary, the invention relates to a multicolour digital printing process. The process comprises (1) providing a first and a second liquid toner, each of which comprising toner particles and a substantially non-polar carrier liquid, wherein said first liquid toner comprises black toner particles and wherein said second liquid toner comprises toner particles in a colour different to black; (2) transferring developed portions of the first and the second liquid toner to a first side of a substrate; (3) fusing said developed portions of the first and the second liquid toner into first and second toner films adhered on the substrate, comprising the steps of exposing the first side of the substrate to infrared radiation, and subsequent contact fusing, and thereafter; (4) carrying out a further transfer step, wherein at least one further developed portion of liquid toner is transferred to a side of the substrate. Herein the substrate is conditioned for the further transfer step by maintaining a substantially uniform water content therein during and after the fusing step. Particularly, the conditioning of the substrate occurs by limiting heating up of the first film, thereby avoiding that the first toner film acts as a heat source for the underlying substrate portion. More particularly, first and second toner films warm up under the exposure to the infrared radiation to temperatures differing at most 15° C. One way of achieving this is a reduction in carbon black content of the first liquid toner, for instance to at most 20 wt % of the total amount of pigment (also including dyes).

1. A multicolour digital printing process comprising
providing a first and a second liquid toner, each of which comprises toner particles and a substantially non-polar carrier liquid, wherein said first liquid toner comprises black toner particles and wherein said second liquid toner comprises toner particles in a colour different than black,
transferring developed portions of the first and the second liquid toner to a first side of a substrate,
fusing said developed portions of the first and the second liquid toner into first and second toner films adhered on the substrate, comprising the steps of exposing the first side of the substrate to infrared radiation, and subsequent contact fusing, and thereafter
carrying out a further transfer step, wherein at least one further developed portion of liquid toner is transferred to a side of the substrate,
wherein the substrate is conditioned for the further transfer step by limiting heating up of the first film, such that the first and the second toner films warm up under exposure to the infrared irradiation to temperatures differing at most 15° C.

2. The multicolour digital printing process as claimed in claim 1, wherein the substrate conditioning involves maintaining a substantially uniform water content in the substrate, between substrate areas below the first film and substrate areas below the second film.

3. The multicolour printing process as claimed in claim 1, wherein the carrier liquid is chosen to have a boiling temperature above the temperature reached in the fusing step.

4. The multicolour printing process as claimed in claim 3, further comprising the step of removing carrier liquid mechanically from the substrate.

5. The multicolour printing process as claimed in claim 1, wherein the process is further controlled such that the first and second toner film warm up in the first fusing step to temperatures of at least 70° C.

6. The multicolour printing process as claimed in claim 1, wherein the further transfer step occurs to the other side of the substrate.

7. The multicolour printing process as claimed in claim 6, wherein the further transfer step involves a transfer of developed portions of at least a first and a second liquid toner.

8. The multicolour printing process as claimed in claim 1, wherein the further transfer step comprises fusing said developed portions of liquid toner into toner film adhered on the second side of the substrate, which fusing comprises the steps of exposing the second side of the substrate to infrared radiation, and subsequent contact fusing.

9. The multicolour printing process as claimed in claim 1, wherein the first liquid toner has an absorbance at 800 nm of at most 0.8, after application on a substrate and fusing to obtain a optical density in the range of 1.8 and 1.9 in the visual range, which absorbance is defined as a logarithmic ratio of an intensity of reflected light from the printed substrate to an intensity of reflected light from the unprinted substrate.

10. The multicolour printing process as claimed in claim 1, wherein the first liquid toner comprises black toner particles with at most 20 wt % carbon black (CB7) pigment relative to the total pigment in the first liquid toner.

11. The multicolour printing process as claimed in claim 10, wherein the black toner particles comprise a mixture of cyan, yellow and magenta pigment, and wherein the amount of cyan, yellow and magenta pigment is in total more than 60 wt % of the total pigment in the first liquid toner.

12. The multicolour printing process as claimed in claim 11, wherein the first liquid toner comprises black toner particles containing 20-35 wt % pigment or dye.

13. The multicolour printing process as claimed in claim 1, wherein the toner particles have a volume based median particle size (dv50) of 1.5-2.5 μm.

14. The multicolour printing process as claimed in claim 1, wherein the substrate is moved relative to transfer and fusing stations in use for the transfer and fusing steps with a linear speed of at least 0.5 m/s.

15. A multicolour digital printing apparatus comprising:
a first transfer station for transfer of a developed portion of a first liquid toner to a first side of a substrate;
a second transfer station for transfer of a developed portion of a second liquid toner to the first side of the substrate
a fusing station comprising a source of infrared radiation emitted to the first side of the substrate, and means for contact fusing in the form of a plurality of heated rollers, so as to convert the first and second liquid toner into first and second toner films adhered to the substrate,
and further comprising downstream of said fusing station:
at least one further transfer station for transfer of a developed portion of liquid toner to a side of the substrate;
a further fusing station comprising a source of infrared radiation emitted to the first side of the substrate, and means for contact fusing in the form of a plurality of heated rollers, wherein the multicolour digital printing apparatus further comprises a control device for controlling the fusing station, such that the first and the second toner films warm up under exposure to the infrared irradiation to temperatures differing at most 15° C.

16.-28. (canceled)

29. The multicolour printing process as claimed in claim 14, wherein the substrate is moved relative to the transfer and fusing stations with a linear speed of at least 1.0 m/s.

30. The multicolour printing apparatus as claimed in claim 15, wherein the control device is configured for controlling the source of infrared radiation.

31. The multicolour digital printing apparatus as claimed in claim 15, further comprising a liquid removal unit for removal of liquid from the substrate.

32. The multicolour digital printing apparatus as claimed in claim 31, wherein the liquid removal unit is arranged downstream of the source of infrared irradiation and upstream of the means for contact fusing.

33. The multicolour digital printing apparatus as claimed in claim 31, wherein the liquid removal unit comprises a means for applying a voltage difference over the liquid toner dispersion.
